(19) United States
(12) Patent Application Publication
(10) Pub. No.: US 2007/0107304 A1
(43) Pub. Date: May 17, 2007

(54) Self watering legged sheet

(76) Inventor: Jianhua Fan, Nashville, TN (US)

Correspondence Address: FAN JIANHUA, 5800 Maudina Ave. C2, Nashville, TN, 37209, US

(21) Appl. No.: 11/590,474

(22) Filed: Nov. 1, 2006

(30) Foreign Application Priority Data
Nov. 11, 2005 (CN) 200520105753.5

(51) Int. Cl. A01G 9/00

(52) U.S. Cl. 47/65.5; 47/32.7

(57) ABSTRACT

A self watering legged sheet includes a flat board, a plurality of leg, the legs extending downwardly from/or connecting to the flat board, the legs have a side wall, the shape of the flat board and the legs can be vary, a plurality of air vent hole disposed on the board. Further, a bottom wall may be dispose on each leg, at least one hole disposed on the bottom wall or on the side wall of the leg near the bottom wall, at least one connecting part disposed on the side of the sheet. Furthermore, the sheet having a side wall extending upwardly from side of the flat board, at least one connecting part disposed on the side wall. Yet, a movable connecting part can be used instead of the fixed connecting part either on the side of the flat board or on the side wall.

### RELATED PATENT APPLICATION

This application claims the benefit of an international application, the China's serial number is 200520105753.5, filed on Nov. 11, 2005, entitled “Legged cultural tray”, by Jianhua Fan (see attached copy of the application).

### BACKGROUND OF THE INVENTION

I. Field of the Present Invention

The present invention relates to a self watering legged sheet with a plurality of leg, more particularly to a self watering legged sheet with side walls, and further particularly to a self watering legged sheet with connection part on side of the sheet.

II. Description of the Prior Art

The European method for roof greening (FIG. 11) is a egg carton shaped sheet. A fiber cloth layer is glued on top of the sheet to support soil and plants, and an air vent and water reserve space being created. While the sheet is in use, plant root grows down, pass through the fiber cloth and air vent layer, then reach to water reserve area to drink the reserved water. The problems of the European method are: needs multiple layer; complicated to use; low water reserve capacity; root grows into no soil layer; no connection part disposed on the sheets, etc.

### SUMMARY OF THE INVENTION

The present invention relates to a self watering legged sheet with a plurality of leg, more particularly to a self watering legged sheet with side walls, and further particularly to a self watering legged sheet with connection part on side of the sheet.

The present invention discloses a self watering legged sheet. The self watering legged sheet can be used in different area, such as roof, greenhouse, nursery field, concrete surface, and does not needs multiple layer, also having a much high water reserve capacity etc.

In one embodiment of the present invention, a self watering legged sheet includes a flat board, a plurality of leg connecting to the flat board at a first end of the leg, means they are in two pieces, or the legs extending downwardly from the flat board, means they are in one piece. The legs have a side wall and a fluid conduit between the first end and second end of the leg for fluid communication while it is in use.

Further in one embodiment, the legs have a bottom wall at second end, at least one hole disposed on the bottom wall or on the lower side wall for fluid communication to out side of the leg.

Still in one embodiment, a plurality of air vent hole disposed on the flat board.

Yet in one embodiment, the sheet includes connection parts on edges of the flat board.

Further in one embodiment, a side wall extending upwardly from or connectinig to the edge of the flat board.

Still in one embodiment, the connection parts disposed on the up edge of the side wall.

Yet in one embodiment, the connection part is movable. While the movable connection part be used on flat board, there are receive holes only on edge of the sheet. While the movable connection part be used on side walls of the flat board, it directly clipped two side walls of two sheet together. So that, no receive holes are needed.

Still in one embodiment, shape of the leg can be vary.

One advantage of the above inventions is that the root of the plant placed on the sheet is prevented/limited from extending to a fluid holding area. So that the root of the plant is not easily damaged by excessive fluid, the root fully contacts soil and absorbs nutrition completely, then the plant grows much healthy. Further advantage is that the sheet has a much large fluid holding space, the water holding space is created by the legs while it is in use. So that it is not necessary to nurse the plant very frequently, and huge rain water can be utilized. Furthermore, the sheet can be easily applied to flat roof, slope roof, concrete surface, greenhouse, nursery field, etc.

These and various other advantages and features of novelty which characterize the invention are pointed out with particularity in the claims annexed hereto and forming a part hereof. However, for a better understanding of the invention, its advantages and objects obtained by its use, reference should be made to the drawings which form a further part hereof, and to the accompanying descriptive matter, in which there is illustrated and described a preferred embodiment of the inventions.

### BRIEF DESCRIPTION OF THE DRAWINGS

A better understanding of the construction and operational characteristics of a preferred embodiments can be realized from a reading of the following detailed description, especially in light of the accompanying drawings in which like reference numerals in the several views generally refer to corresponding parts.

FIG. 1 is a perspective view of a self watering legged sheet in accordance with the present invention.

FIG. 2 is a perspective view of a self watering legged sheet with side wall in accordance with the present invention.

FIG. 3 is a front side view of FIG. 1 in accordance with the present invention.

FIG. 4 is a front side view of FIG. 2 in accordance with the present invention.

FIG. 5 is a right side view of FIG. 1 in accordance with the present invention.

FIG. 6 is a right side view of FIG. 2 in accordance with the present invention.

FIG. 7A is a perspective view of a leg of self watering legged sheet in accordance with the present invention.

FIG. 7B is a perspective view of an another leg of self watering legged sheet in accordance with the present invention.

FIG. 8 is a perspective view of a leg with supports in accordance with the present invention.

FIG. 9 is a perspective view of another shape of a leg in accordance with the present invention.

FIG. 10 is perspective view of self watering legged sheet (not show) apply to a slop roof in accordance with the present invention.

### DETAILED DESCRIPTION OF THE PREFERRED EMBODIMENT

The present invention relates to a self watering legged sheet with a plurality of leg, more particularly to a self watering legged sheet with side walls, and furthermore particularly to a self watering legged sheet with connection parts.

In the following description of the exemplary embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

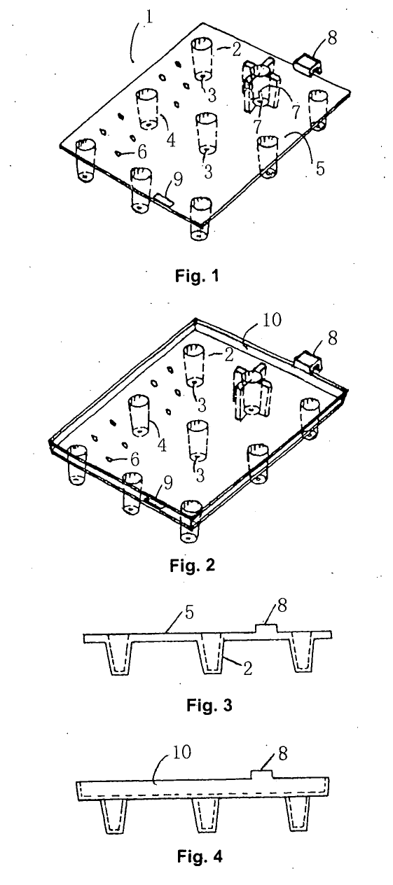

Referring now to FIG. 1, there is, general illustrated by reference numeral 1, a self watering legged sheet in accordance with the principles of the present invention. The self watering legged sheet 1 has a flat board 5, a plurality of leg 2, a plurality of air vent hole 6 on the flat board 5, a connection part 8, a connection part receive hole 9, It is appreciated that more than one connection part and receive hole can be disposed on each side of the sheet. The leg 2 has a side wall 4.

Further in FIG. 1, a bottom wall disposed on the lower end of the leg if needed, and at least one hole 3 disposed either on bottom wall, lower side wall, or between the bottom and side walls. The legs extending downwardly from the flat board 5, numeral of the legs depends on the size of the sheet, the shape of the leg can be vary, such as the leg 7, etc. While the self watering legged sheet is in use, a plastic film, rubber sheet, or others material may be used to create a tray like water reservoir for holding fluid. Concrete can be used to create the reservoir too. The height of side wall of the reservoir depends on the length of the legs or customer needs. The reservoir is not the part in present invention, but it has to be applied while the self watering legged sheet is in use.

Furthermore in FIG. 1, each side of the sheet has connection receive hole 9 only while a movable connection part (not show) be used instead of the fixed connection part 8. The function of movable connection part is like a clip.

FIG. 2 illustrates a self watering legged sheet has a side wall 10 which extending upwardly from edge of the sheet, the height of the side wall depends on the use or customer needs. The connection part 8 in FIG. 1 can be disposed on the edge of each side wall, The connection part 8 on one side of one sheet clips on one side wall of another sheet. So that the receive hole 9 in FIG. 1 is not needed in FIG. 2. Numeral of connection part 8 on each side of the sheet is not limited. Also, a separate side wall may be connect to the flat sheet instead of the extending side wall.

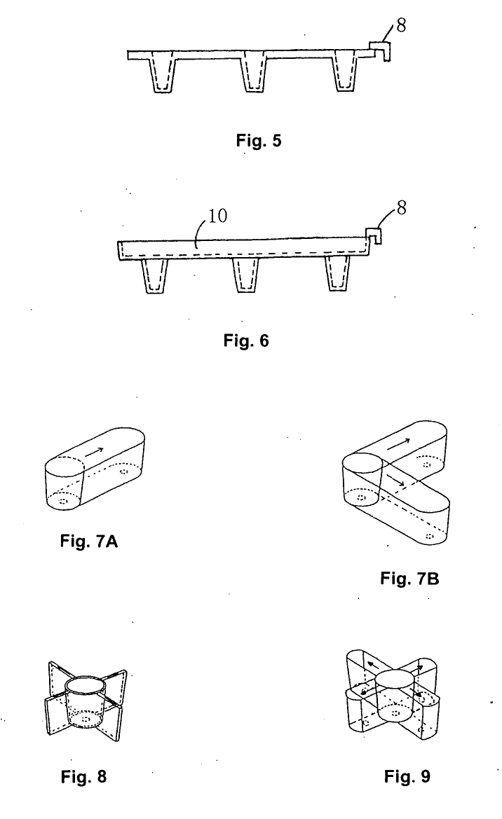

FIGS. 3 and 5 shown the front and side view of FIG. 1. FIGS. 4 and 6 shown the front and side view of FIG. 2.

FIGS. 7A, 7B, 8, 9 shown different shape of the leg, it is appreciated that others different shapes of the leg can be used in present invention.

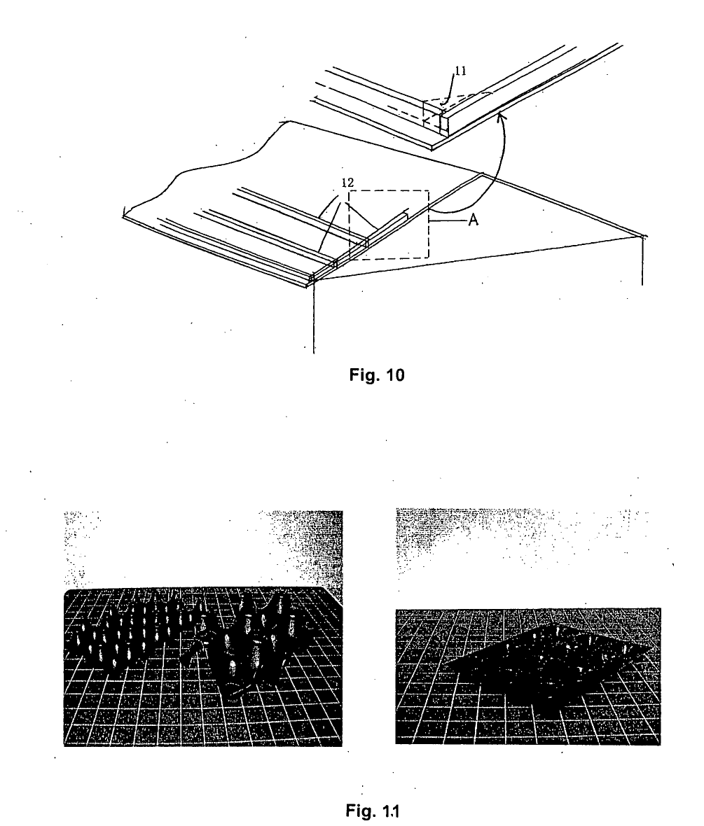

FIG. 10 illustrates the self watering legged sheet (not shown) can be applied on slope roof. The rib 12 creates space 11 for reserving water. The reserved water is absorbed by soil in legs of the sheet, then wicking up and disperses to upper soil layer for plants use.

The present invention can also be applied on concrete surface such as wayside, or in greenhouse and nursery field to reduce water lose and environment problems.

The foregoing description of the exemplary embodiment of the invention has been presented for the purpose of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A self watering legged sheet apparatus, comprising:
a flat board, shape of the flat board can be vary, such as square, triangle or rectangle; and
a plurality of air vent hole disposed on the board; and
a plurality of leg, the legs extending downwardly from or connecting to the flat board, the legs have a side wall.

2. The legged sheet of claim 1, further comprising a bottom wall on each leg, at least one hole disposed on either the bottom wall, the lower side wall, or between the bottom and lower side wall of the leg for fluid communication between in and out of the leg.

3. The legged sheet of claim 2, further comprising at least one connection part and corresponding receive hole disposed on side of the flat board.

4. The legged sheet of claim 3, wherein the connection part disposed on two side of the flat board connecting to other legged sheets, and other two side of the legged sheet have corresponding receive holes to receive the connection part of other legged sheets.

5. The legged sheet of claim 4, wherein the connection part and corresponding receive holes can be disposed on the same side, each side of the legged sheet has the same numeral of connection part and corresponding receive holes, one connection part on one side of one legged sheet matched one corresponding receive holes on one side of another legged sheet.

6. The legged sheet of claim 1, wherein shape of the legs can be vary.

7. The legged sheet of claim 1, further comprising a side wall of the legged sheet, the side wall extending upwardly from the edge of the legged sheet, height of the side wall can be vary.

8. The legged sheet of claim 7, further comprising at least one connection part disposed on upper edge of two side wall of the legged sheet, while the legged sheet is in use, the each side connection parts clip on a side wall of other two legged sheets, and left two side walls being clipped by the connection parts on the other two legged sheets.

9. The legged sheet of claim 8, wherein the connection part can be disposed on each side wall, side wall between the connection parts receives a connection part of another legged sheet.

10. The legged sheet of claim 7, wherein the side wall of two legged sheets can be clipped together by movable clips.

11. The legged sheet of claim 3, further comprising at least one movable clip be used instead of connection part, each side of the legged sheet has corresponding receive holes only, each side connected to another legged sheet by movable clips while the legged sheet is in use.

12. The legged sheet of claim 7, wherein a separate side wall can be connected to the edge of the legged sheet instead of the side wall which extending upwardly from the flat board.
